(19) United States
(12) Patent Application Publication
(10) Pub. No.: US 2015/0277828 A1
(43) Pub. Date: Oct. 1, 2015

(54) Image Forming System, Portable Terminal, and Recording Medium That Ensure Intuitive Setting of Page Orientation from Portable Terminal

(71) Applicant: Kyocera Document Solutions Inc., Osaka (JP)

(72) Inventors: Masaya Okuda, Osaka (JP); Satoshi Kawakami, Osaka (JP); Yuri Moritani, Osaka (JP); Yoshitaka Matsuki, Osaka (JP)

(21) Appl. No.: 14/668,990

(22) Filed: Mar. 26, 2015

(30) Foreign Application Priority Data
Mar. 26, 2014 (JP) 2014-064391

(51) Int. Cl. G06F 3/12; H04N 1/00

(52) U.S. Cl. CPC G06F 3/1256; G06F 3/1204; G06F 3/1205; G06F 3/1254; G06F 3/1242; G06F 3/1292; H04N 1/00129; H04N 1/0044; H04N 2201/0072; H04N 2201/0074

(57) ABSTRACT

An image forming system includes an image forming apparatus and a portable terminal. The image forming apparatus includes: a preview image creating circuit that creates preview image data from image data; and a preview image transmitting circuit that transmits the preview image data to the portable terminal. The portable terminal includes: a preview image data receiving circuit that receives the preview image data from the image forming apparatus; a preview image display circuit that displays an image of the preview image data; and a page orientation setting circuit that sets the page orientation whether a top side of the original document is an upper side, or a top side of the original document is a left side corresponding to a direction of the image of the preview image data.

### INCORPORATION BY REFERENCE

This application is based upon, and claims the benefit of priority from, corresponding Japanese Patent Application No. 2014-064391 filed in the Japan Patent Office on Mar. 26, 2014, the entire contents of which are incorporated herein by reference.

### BACKGROUND

Unless otherwise indicated herein, the description in this section is not prior art to the claims in this application and is not admitted to be prior art by inclusion in this section.

An image forming apparatus, which is a printer, a multifunction printer, or a multifunction peripheral, can transmit image data of a read original document and image data (hereinafter referred to as “preview image data”) of a print image of the image (hereinafter referred to as “preview”) to a portable terminal such as a mobile phone, a smart phone, or a tablet terminal by wireless communication. Receiving preview image data from the image forming apparatus by the portable terminal and indicating the preview image on an operation panel of the portable terminal ensures the user to confirm print settings by the preview image on hand. For example, a control unit that is mounted on a transportable terminal device (such as portable terminal) creates a preview image of Web data extracted from a Web server to indicate on the display of the terminal device. This ensures the user to confirm print settings by the preview image on hand. The control unit causes a printer such as an image forming apparatus to switch page orientation when the terminal device is portrait-oriented (the short side of the terminal device is upper side), the portrait print, on which the print job is executed from top to bottom of the long side of the original document, is executed; and when the terminal device is landscape-oriented (the long side of the terminal device is upper side), the landscape print, on which the print job is executed from top to bottom of the short side of the original document, is executed.

### SUMMARY

An image forming system according to an aspect of the disclosure includes an image forming apparatus and a portable terminal. The image forming apparatus includes: a preview image creating circuit that creates preview image data from image data; and a preview image transmitting circuit that transmits the preview image data to the portable terminal. The portable terminal includes: a preview image data receiving circuit that receives the preview image data from the image forming apparatus; a preview image display circuit that displays an image of the preview image data; and a page orientation setting circuit that sets the page orientation whether a top side of the original document is an upper side, or a top side of the original document is a left side corresponding to a direction of the image of the preview image data.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a constitution of an image forming system according to an embodiment of the disclosure.

FIG. 2 illustrates a functional configuration of an image forming apparatus and a portable terminal of the image forming system according to the embodiment.

FIGS. 3A to 3C illustrate an operating procedure of the user to set the page orientation from the portable terminal according to the embodiment.

FIG. 4 illustrates a flow of a process for setting the page orientation of the portable terminal according to the embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration to execute the disclosure (hereinafter referred to as “embodiment”) with reference to the drawings. The embodiment sets the page orientation by the user's making the main body of the portable terminal in portrait-oriented or landscape-oriented while the preview image is displayed on the portable terminal.

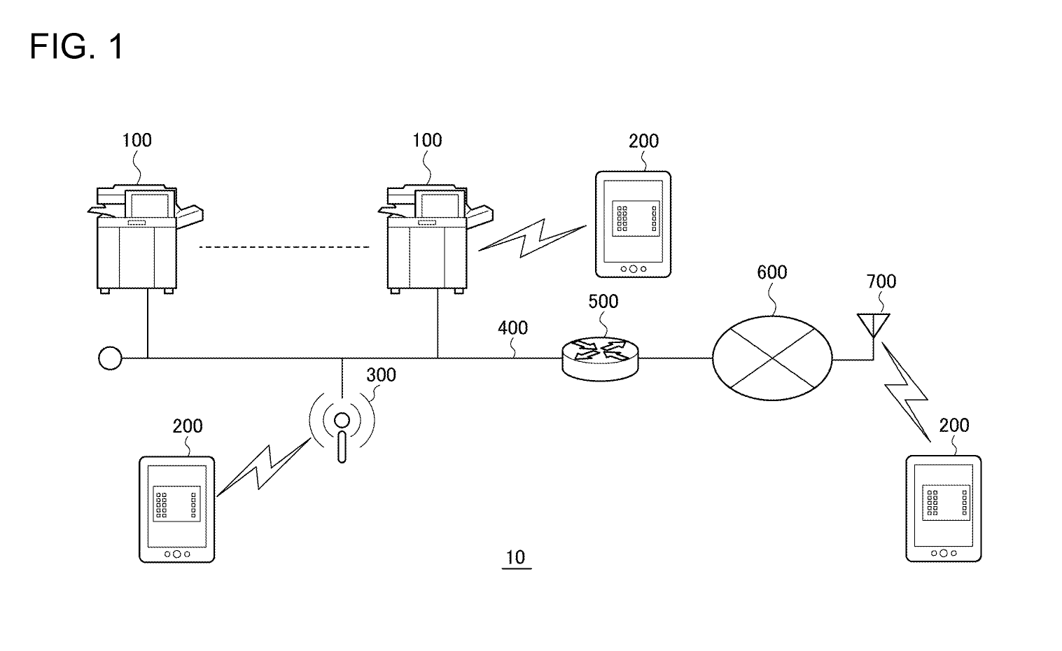

First, the system configuration of an image forming system 10 of the embodiment will be described by referring to FIG. 1. As illustrated in FIG. 1, the image forming system 10 includes a plurality of image forming apparatus 100, a plurality of portable terminal 200, an access point 300, a network 400, a router 500, an Internet 600, and an access point 700. The image forming apparatus 100 and the access point 300 are connected to the network 400, and the network 400 is connected to the Internet 600 via the router 500.

The image forming apparatus 100 is a printer, a multifunction printer, a multifunction peripheral, or a multi-functional peripheral. The image forming apparatus 100 can transmit and receive data to/from the portable terminal 200 via short-range wireless communication, the network 400, or the Internet 600.

The portable terminal 200 is a mobile phone, a smart phone, a tablet terminal or similar device, and can transmit and receive data to/from the image forming apparatus 100 via short-range wireless communication, the access point 300 of the network 400, or the access point 700 of the Internet 600.

The access point 300 is connected to the network 400, and connects the portable terminal 200, which requests to be connected to the access point 300 by wireless communication, to the network 400.

The network 400 is a network (intranet, for example) such as a Local Area Network (LAN), and a plurality of image forming apparatus 100 and the access point 300 are connected to the network 400.

The router 500 is connected to the network 400, and connects the network 400 to the Internet 600.

The Internet 600 is an IP network such as an Internet and an intranet, while a plurality of portable terminal 200 connect to the Internet 600 via the access point 700.

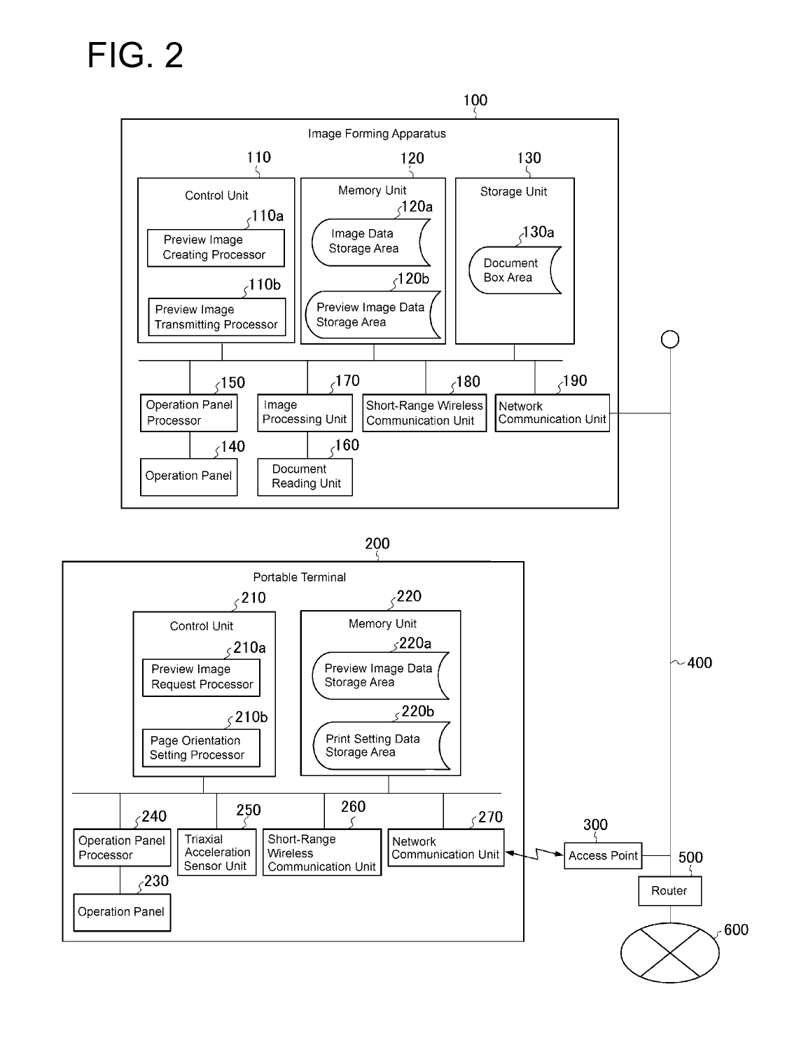

Next, the functional configuration of the image forming apparatus 100 and the portable terminal 200 of the image forming system 10 will be described by referring to FIG. 2. The image forming apparatus 100 and the portable terminal 200 illustrated in FIG. 2 indicate the functional configuration of one image forming apparatus 100, which connects to the network 400, and one portable terminal 200, which connects to the network 400 via the access point 300, in the image forming system 10 illustrated in FIG. 1. The other image forming apparatuses 100 and portable terminals 200 illustrated in FIG. 1 have the similar functional configuration.

First, the functional configuration of the image forming apparatus 100 will be described. The image forming apparatus 100 illustrated in FIG. 2 includes a control unit 110, a memory unit 120, a storage unit 130, an operation panel 140, an operation panel processor 150, a document reading unit 160, an image processor 170, a short-range wireless communication unit 180, and a network communication unit 190. These respective units are connected together via a bus or similar member. The control unit 110 includes a preview image creating processor 110a and a preview image transmitting processor 110b. The memory unit 120 includes an image data storage area 120a and a preview image data storage area 120b. The storage unit 130 includes a document box area 130a.

The control unit 110 is a circuit including a main storage unit such as a RAM and a ROM, and including a control unit such as a Central Processing Unit (CPU). The control unit 110 controls the overall image forming apparatus 100 including various I/Os, an interface such as a Universal Serial Bus (USB), a bus controller, and a similar device. The preview image creating processor 110a is a circuit that extracts the image data from the image data storage area 120a, creates the preview image data from the extracted image data, and stores the preview image data in the preview image data storage area 120b. When receiving a notification of the request for the preview image from the portable terminal 200, the preview image transmitting processor 110b is a circuit that extracts the preview image data from the preview image data storage area 120b and transmits the preview image data to the portable terminal 200. The preview image creating processor 110a and the preview image transmitting processor 110b functions as a preview image creating unit and a preview image transmitting unit, respectively.

The memory unit 120 is an auxiliary storage device such as a flash memory and stores the program and data of the process that the control unit 110 executes. The image data storage area 120a stores image data that is read from the document reading unit 160 and image data that is received from the other image forming apparatus 100 and portable terminal 200 via the network communication unit 190. The preview image data storage area 120b stores the preview image data that the image forming apparatus 100 creates from the image data.

The storage unit 130 is an auxiliary storage device such as a hard disk drive that stores the data and program. The document box area 130a includes a plurality of document boxes for every user. The respective document box stores image data that the user controls.

The operation panel 140 is a liquid crystal panel that displays an operation screen, an image of the image data, and a preview image of the preview image data, and accepts an operation by the user.

The operation panel processor 150 is a circuit that performs: the process to display operation items relating to the functions included in the image forming apparatus 100 on the operation panel 140, the process to display the image and the preview image on the operation panel 140, and/or the process to receive the user operation from the operation panel 140. The operation panel processor 150 functions as a preview image display unit.

When the user performs a reading operation from the operation panel 140, the document reading unit 160, such as a document scanner, reads the original document set on the platen of the image forming apparatus 100, and outputs the read data to the image processor 170.

When receiving the read data from the document reading unit 160, the image processor 170 that operates as a circuit converts the data into the image data of the printable image and the image data of the image transmittable by FAX and e-mail.

The short-range wireless communication unit 180 is a circuit that communicates directly in a short-range with the portable terminal 200 via Bluetooth (registered trademark) as a short-range wireless communication standard or an infrared communication.

The network communication unit 190 is a circuit including an attachable LAN interface to connect to the network 400.

Next, the functional configuration of the portable terminal 200 will be described. The portable terminal 200 illustrated in FIG. 2 includes a control unit 210, a memory unit 220, an operation panel 230, an operation panel processor 240, a triaxial acceleration sensor unit 250, a short-range wireless communication unit 260, and a network communication unit 270. These respective units are connected together via a bus or similar member. The control unit 210 includes a preview image request processor 210a and a page orientation setting processor 210b. The memory unit 220 includes a preview image data storage area 220a and a print setting data storage area 220b.

The control unit 210 is a circuit including the main storage unit such as the RAM and the ROM, and the control unit such as the Central Processing Unit (CPU). The control unit 210 controls the overall portable terminal 200 including various I/Os, an interface such as a Universal Serial Bus (USB), a bus controller, and a similar device. The preview image request processor 210a is a circuit that transmits a notification of the request for the preview image to the image forming apparatus 100. With receiving the preview image data from the image forming apparatus 100, the preview image request processor 210a stores the preview image data in the preview image data storage area 220a. The page orientation setting processor 210b is a circuit that detects whether the main body of the portable terminal 200 is portrait-oriented or landscape-oriented to set the direction of the original document. The page orientation setting processor 210b functions as a direction detecting unit, while the preview image request processor 210a functions as a preview image data receiving unit.

The memory unit 220 is an auxiliary storage device such as a flash memory and stores the program and data of the process that the control unit 210 executes. The preview image data storage area 220a stores the preview image data receiving from the image forming apparatus 100. The print setting data storage area 220b stores the print setting data set by a print setting screen 800 (described later).

The operation panel 230 is a liquid crystal panel that displays the operation screen, the setting screen, the image of the image data, and the preview image of the preview image data, and accepts the operation and setting by the user.

The operation panel processor 240 is a circuit that performs: the process to display the screen of operation items and setting items relating to the functions included in the portable terminal 200 on the operation panel 230, the process to display the image and the preview image on the operation panel 230, and/or the process to receive the user operation and setting from the operation panel 230.

The triaxial acceleration sensor unit 250 is a circuit, such as a Micro Electro Mechanical System (MEMS) sensor, that detects the respective accelerations of the X, Y, and Z axial directions to detect the motion such as the gradients of the portable terminal 200.

The short-range wireless communication unit 260 is a circuit that communicates directly in a short-range with the image forming apparatus 100 via Bluetooth (registered trademark) as a short-range wireless communication standard or an infrared communication.

The network communication unit 270 is a circuit that connects to the network 400 via the access point 300. The network communication unit 270 also connects to the Internet 600 via the access point 700.

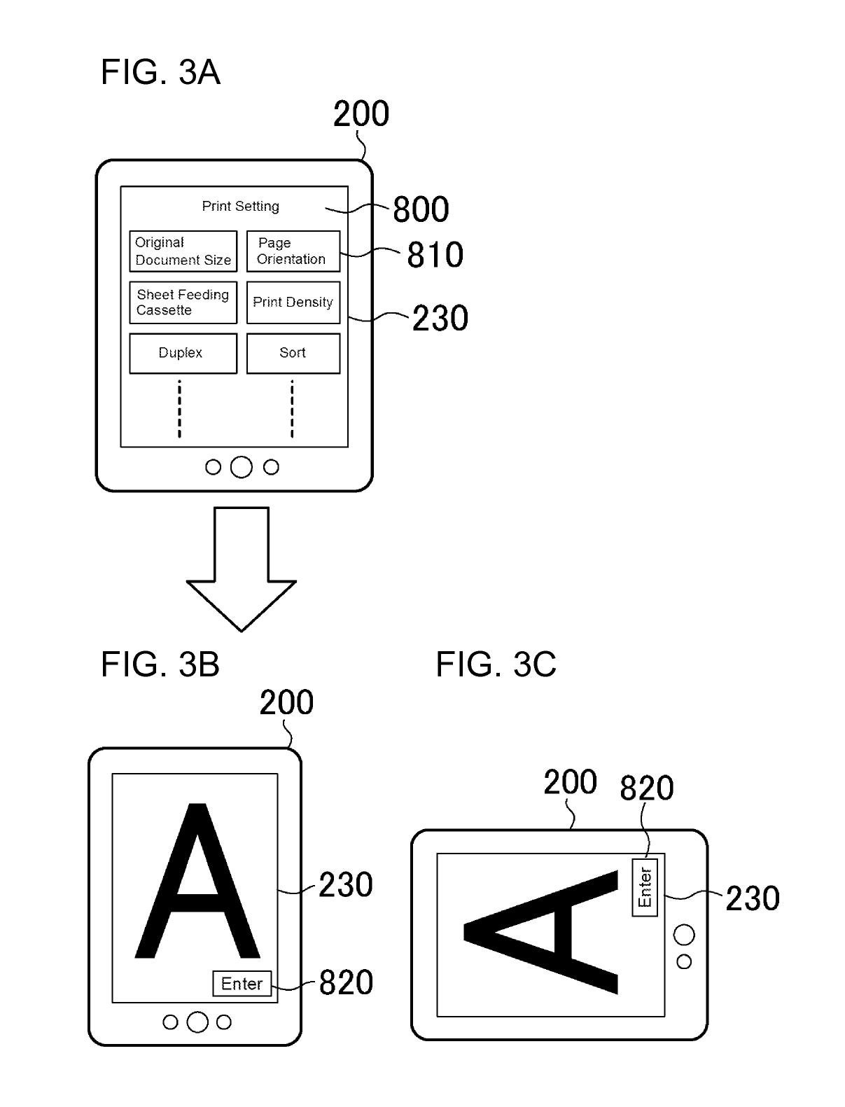

Next, the operating procedure of the user to set the page orientation from the portable terminal 200 according to the embodiment will be described by referring to FIGS. 3A, 3B, and 3C. First, the user operates the operation panel 230 to display the print setting screen 800. Then, the print setting screen 800 is displayed on the operation panel 230 as illustrated in FIG. 3A. Next, the user touches a “Page Orientation” button 810 on the print setting screen 800, and the preview image of the original document and an “Enter” button 820 are displayed on the operation panel 230 as illustrated in FIG. 3B. When setting the top edge of the original document at the upper side, the user touches the “Enter” button 820 in a state where the main body and the preview image of the portable terminal 200 are portrait-oriented as illustrated in FIG. 3B. When setting the top edge of the original document on the left side, the user touches the “Enter” button 820 in a state where the main body and the preview image of the portable terminal 200 are landscape-oriented as illustrated in FIG. 3C. If an automatic rotation function of the portable terminal 200 is set enable, having the main body of the portable terminal 200 in landscape-oriented causes the preview image to rotate automatically to the portrait-oriented. To avoid this, the automatic rotation function should be set disable. This operating procedure ensures the user to set the top edge of the original document on upper side (Top Edge on Top), or to set the top edge of the original document on left side (Top Edge on Left).

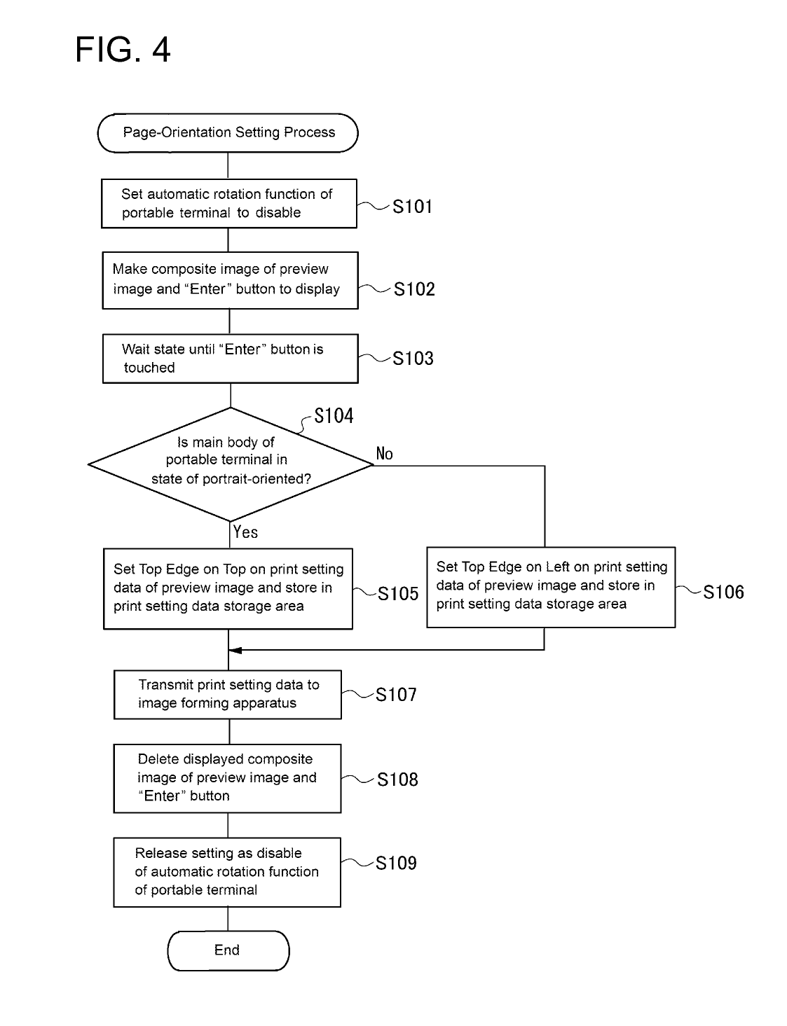

Next, the procedure to set the page orientation from the portable terminal 200 will be described more in detail by referring to a flowchart illustrated in FIG. 4.

First, the user operates the operation panel 230 of the portable terminal 200 to display the print setting screen 800. Then, the operation panel processor 240 displays the print setting screen 800 on the operation panel 230. Next, the user touches the “page orientation” button 810 on the print setting screen 800. Then, the notification of the request for setting the page orientation is output from the operation panel processor 240 to the control unit 210. With receiving the notification of the request for setting the page orientation, the control unit 210 activates the preview image request processor 210a. Next, the preview image request processor 210a transmits the notification of the request for the preview image to the image forming apparatus 100. With receiving the preview image data from the image forming apparatus 100, the preview image request processor 210a stores the preview image data in the preview image data storage area 220a. Next, the control unit 210 detects the termination of the preview image request process by the preview image request processor 210a, and then activates the page orientation setting processor 210b. Subsequently, the page orientation setting processor 210b starts the page orientation setting process. The following describes the page orientation setting process illustrated in FIG. 4 in the order of the steps of the flowchart. The operation panel processor 240 functions as a print setting screen display unit.

First, at step S101, the page orientation setting processor 210b sets the automatic rotation function to disable. The automatic rotation function rotates the image displayed on the operation panel 230 of the portable terminal 200 to the direction identical to the portable terminal 200.

Next, at step S102, the page orientation setting processor 210b extracts the preview image data from the preview image data storage area 220a, and makes a composite image of the preview image and the “Enter” button 820 to display on the operation panel 230.

Next, at step S103, the page orientation setting processor 210b is placed in a wait state until the touching of the “Enter” button 820 is notified from the operation panel processor 240, and after receiving the notification of the touching of the “Enter” button 820, the process proceeds to Step S104.

Next, at step S104, the page orientation setting processor 210b uses the triaxial acceleration sensor unit 250 to determine whether the main body of the portable terminal 200 is in a state of portrait-oriented. In a state where the main body of the portable terminal 200 is portrait-oriented (Yes at Step S104), the process proceeds to Step S105. In a state where the main body of the portable terminal 200 is landscape-oriented rotating to landscape-oriented (No at Step S104), the process proceeds to Step S106.

In Yes at Step S104, the page orientation setting processor 210b sets, at step S105, the page orientation that the top edge of the original document is at the upper side (Top Edge on Top) to the print setting data of the displayed preview image, and stores the print setting data in the print setting data storage area 220b. Then, the process proceeds to Step S107.

In No at Step S104, the page orientation setting processor 210b sets, at step S106, the page orientation that the top edge of the original document is at the left side (Top Edge on Left) to the print setting data of the displayed preview image, and stores the print setting data in the print setting data storage area 220b. Then, the process proceeds to Step S107.

Next, at step S107, the page orientation setting processor 210b transmits the print setting data in the print setting data storage area 220b to the image forming apparatus 100 via the network communication unit 270. The page orientation setting processor 210b functions as a print setting data transmitting unit, while the image forming apparatus 100 functions as a print setting data receiving unit.

Next, at step S108, the page orientation setting processor 210b deletes the composite image of the preview image and the “Enter” button 820 that is displayed on the operation panel 230.

Next, at step S109, the page orientation setting processor 210b releases the setting as disable of the automatic rotation function that is set at Step S101, and terminates the page orientation setting process.

As described above, when the user causes the operation panel 230 to display the print setting screen 800 and touches the “page orientation” button 810, the preview image and the “Enter” button 820 are displayed. Next, when the user sets the top side to the upper side (Top Edge on Top) to the original document of the preview image, the main body of the portable terminal 200 is portrait-oriented. When the user sets the top side to the left side (Top Edge on Left) to the original document of the preview image, the main body of the portable terminal 200 is landscape-oriented. This ensures the user to set the page orientation intuitively by performing the performance identical to the setting of the original document on the platen of the image forming apparatus 100 while watching the preview image of the original document displayed on the operation panel 230. This page orientation whether the top side of the original document is at the upper side (Top Edge on Top) or the top side of the original document is at the left side (Top Edge on Left) may be set either when the original document is printed on the paper sheet. However, the page orientation should be set accurately when performing the function of a staple or an enlargement/reduction. As described above, having the main body of the portable terminal 200 in portrait-oriented or in landscape-oriented ensures the user to set the page orientation to perform the staple or the enlargement/reduction as assumed. Transmitting the print setting data from the portable terminal 200 to the image forming apparatus 100 ensures the image forming apparatus 100 to print the original image data of the preview image based on the print setting of the print setting data as the user assumed.

AS illustrated in FIGS. 3A to 3C of the embodiment, when setting the top side of the original document to the upper side (Top Edge on Top), the user touches the “Enter” button 820 in a state where the main body of the portable terminal 200 is portrait-oriented. When setting the top side of the original document to the left side (Top Edge on Left), the user touches the “Enter” button 820 in a state where the main of the portable terminal 200 is landscape-oriented. However, the disclosure is not limited to this. For example, the page orientation of the original document may be determined by touching the “Enter” button 820 in a state where the preview image is portrait-oriented or touching the “Enter” button 820 in a state where the preview image itself is rotated to landscape-oriented.

In the embodiment, the network 400 connects the image forming apparatus 100 to the portable terminal 200, and the network 400 transmits and receives data between the portable terminal 200 and the image forming apparatus 100. However, the disclosure is not limited to this. For example, the short-range wireless communication may connect the image forming apparatus 100 to the portable terminal 200 via the short-range wireless communication unit 180 of the image forming apparatus 100 and the short-range wireless communication unit 260 of the portable terminal 200, and the short-range wireless communication may transmit and receive data between the portable terminal 200 and the image forming apparatus 100. The communication protocol of the Internet 600 may be used to connect the image forming apparatus 100 to the portable terminal 200, and the communication protocol of the Internet 600 may transmit and receive data between the portable terminal 200 and the image forming apparatus 100.

In the embodiment, the image forming apparatus 100 creates the preview image data from the image data. However, the disclosure is not limited to this. For example, the portable terminal 200 may function as an image data receiving unit and receive the image data from the image forming apparatus 100 and create the preview image data from this received image data to display the preview image.

In the embodiment, the composite image of the preview image and the “Enter” button 820 is created to display on the operation panel 230. However, the disclosure is not limited to this. For example, with displaying only the preview image on the operation panel 230, such as an “OK” button included in the portable terminal 200 may be used instead of the “Enter” button 820.

In the embodiment, the print setting data is stored in the print setting data storage area 220b. Then, when receiving the transmission request for the print setting data from the image forming apparatus 100, the portable terminal 200 may transmit the print setting data in the print setting data storage area 220b to the image forming apparatus 100.

In the embodiment, the portable terminal 200 receives the preview image data from the image forming apparatus 100 via the wireless communication. However, the disclosure is not limited to this. For example, with using a portable PC (personal computer) as the portable terminal 200, the PC may be connected directly to the network 400 to receive the preview image data from the image forming apparatus 100.

The image forming system and the portable terminal according to the disclosure ensures the user to set the page orientation of the original document intuitively from the portable terminal in printing the original document.

The image forming system and the portable terminal according to the disclosure is applicable to the portable terminal that can display the image of the preview image data and any other systems that includes the portable terminal.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming system comprising:
an image forming apparatus; and
a portable terminal; wherein
the image forming apparatus includes
a preview image creating circuit that creates preview image data from image data, and
a preview image transmitting circuit that transmits the preview image data to the portable terminal; and
the portable terminal includes
a preview image data receiving circuit that receives the preview image data from the image forming apparatus,
a preview image display circuit that displays an image of the preview image data, and
a page orientation setting circuit that sets the page orientation whether a top side of the original document is an upper side, or a top side of the original document is a left side corresponding to a direction of the image of the preview image data.

2. The image forming system according to claim 1, wherein:
the portable terminal further includes
a main body, and
a direction detecting circuit that detects whether the main body is portrait-oriented or landscape-oriented; and
the portable terminal sets the image of the preview image data as portrait-oriented or landscape-oriented corresponding to whether the main body is portrait-oriented or landscape-oriented.

3. The image forming system according to claim 1, wherein:
the portable terminal includes
a print setting screen display circuit that displays a print setting screen for print setting of the preview image data, and
a print setting data transmitting circuit that transmits print setting data to the image forming apparatus, the print setting data being set on the print setting screen; and
the image forming apparatus further includes a print setting data receiving circuit that receives the print setting data from the portable terminal.

4. The image forming system according to claim 1, wherein the image forming apparatus and the portable terminal are connected via a network.

5. The image forming system according to claim 1, wherein the image forming apparatus and the portable terminal are connected via short-range wireless communications.

6. The image forming system according to claim 1, wherein the image forming apparatus and the portable terminal are connected via the Internet.

7. A portable terminal comprising:
an image data receiving circuit that receives image data from an image forming apparatus;
a preview image creating circuit that creates preview image data from image data;
a preview image display circuit that displays an image of the preview image data; and
a page orientation setting circuit that sets the page orientation whether a top side of the original document is an upper side, or a top side of the original document is a left side corresponding to a direction of the image of the preview image data.

8. The portable terminal according to claim 7, further comprising:
a main body; and
a direction detecting circuit that detects whether the main body is portrait-oriented or landscape-oriented; wherein
the image of the preview image data is set as portrait-oriented or landscape-oriented corresponding to whether the main body is portrait-oriented or landscape-oriented.

9. The portable terminal according to claim 7, further comprising:
a print setting screen display circuit that displays a print setting screen for print setting of the preview image data; and
a print setting data transmitting circuit that transmits print setting data to the image forming apparatus, the print setting data being set on the print setting screen.

10. A non-transitory computer-readable recording medium storing a program for controlling a portable terminal, the program causing the portable terminal to function as:
an image data receiving unit that receives image data from an image forming apparatus;
a preview image creating unit that creates preview image data from the image data;
a preview image display unit that displays an image of the preview image data; and
a page orientation setting unit that sets the page orientation whether a top side of the original document is an upper side, or a top side of the original document is a left side corresponding to a direction of the image of the preview image data.
